(19) United States
(12) Patent Application Publication
(10) Pub. No.: US 2016/0246423 A1
(43) Pub. Date: Aug. 25, 2016

(54) TOUCH SCREEN AND TOUCH PANEL THEREOF

(71) Applicant: SHENZHEN CHINA STAR OPTOELECTRONICS TECHNOLOGY CO., LTD., Shenzhen City, Guangdong (CN)

(72) Inventor: Ruhai FU, Shenzhen, Guangdong (CN)

(73) Assignee: Shenzhen China Star Optoelectronics Technology Co., Ltd., Shenzhen City, Guangdong (CN)

(21) Appl. No.: 14/384,153

(22) PCT Filed: Aug. 19, 2014
(86) PCT No.: PCT/CN2014/084707

§ 371 Date: Sep. 9, 2014

(30) Foreign Application Priority Data
Aug. 5, 2014 (CN) 201410381402

(51) Int. Cl. G06F 3/041; G06F 3/044

(52) U.S. Cl. CPC G06F 3/0416; G06F 3/0412; G06F 3/044

(57) ABSTRACT

The present invention discloses a touch panel, of which the effective touch area is non-rectangular. The touch panel comprises a touch sensor array system covering the effective touch area. The touch sensor array system comprises a plurality of touch sensor units which the shape is hexagon, and the touch sensor units are arranged in a honeycomb. The present invention also discloses a touch screen. Through the above mentioned manner, the present invention enables the touch sensor unit to cover the non-rectangular effective touch area better, and assures the consistency of the touch weight.

### FIELD OF THE INVENTION

The present invention relates to touch technical field, and in particular, relates to the touch screen and the touch panel thereof.

### BACKGROUND OF THE INVENTION

With the development of technology, every kind of digital product comes into people's daily lives. It brings a lot of convenience to people and they have more and higher requirement of digital product. For example, the intelligent wearable devices have been more and more popular and become the research focus the electronic manufacturers compete to each other, especially the intelligent watch. In order to keep up with traditional aesthetic requirements, the display panel and the corresponding touch panel of the intelligent watch should be made into circular.

In the prior art, the rectangular touch sensor units are generally used to arrange in the effective touch area. Please refer to FIG. 1, which is a schematic diagram shows the arrangement of the touch sensor units of the circular effective touch area of the touch panel of the prior art. The interior of the small circular area 10 is the effective touch area 10 and the touch sensor units 11 are arranged in the effective touch area 10 as shown in FIG. 1. The effective touch area 10 is not totally covered by the rectangular touch sensor units 11 without using the perfect array of the touch sensor unit 11, so that the touch performance of the edge of the effective touch area 10 is not very sensitive and even the touch function is not working.

Therefore, it is necessary to provide a touch screen and a touch panel of the present invention to solve the above mentioned problem.

### SUMMARY OF THE INVENTION

The main technical problem solved by the present invention which provides a touch screen and a touch panel thereof is that the rectangular touch sensor cannot cover the whole effective touch area without choosing the right touch sensor array to identify the touch position in the prior art.

In order to solve the technical problem, the solution provided by the present invention is to provide a touch panel, and the touch panel has an effective touch area which is non-rectangular. The touch panel comprises a touch sensor array system covering the effective touch area, and the touch sensor array system comprises a plurality of touch sensor units, and the shape of the touch sensor unit is hexagon, and they are arranged in a honeycomb.

Where, each of the touch sensor units comprises a sensor electrode, and the shape of the sensor electrode is hexagon, and the sensor electrodes are arranged in a honeycomb.

Where, the touch sensor array system further comprises a plurality of electrode leads, and the electrode lead connects with the sensor electrodes in the same row or column.

Where, the electrode lead bends and extends between the neighboring rows or the neighboring columns of the sensor electrodes and the width of the electrode lead gradually changes in the direction of the row and column.

Where, the touch sensor unit comprises a sensor electrode and a driving electrode, and the sensor electrode surrounds the driving electrode by insulation, and the shape of the sensor electrode is hexagon, and the sensor electrodes are arranged in a honeycomb.

Where, the touch senor array system further comprises a plurality of electrode leads, and the electrode lead connects with the driving electrodes in the same row or the same column, and the sensor electrodes connect with each other in a row or column.

Where, the electrode lead bends and extends between the neighboring rows or the neighboring columns of the driving electrodes and the width of the electrode lead gradually changes in the direction of the row and column.

Where, the shape of the touch sensor unit is regular hexagon.

The effective touch area is circular.

In order to solve the technical problem, the present invention adopts the other solution is a touch screen, wherein the touch screen comprises a display panel and a touch panel located on the display panel, and an effective touch area of the touch panel is non-rectangular, wherein the touch panel comprises a touch sensor array system covering the effective touch area, and the touch sensor array system comprises a plurality of touch sensor units, and the shape of the touch sensor unit is hexagon and the touch sensor units are arranged in a honeycomb, and an effective display area of the display panel is non-rectangular and installed correspond with the effective touch area of the touch panel.

Where, the touch sensor unit comprises a sensor electrode, and the shape of the sensor electrode is hexagon, and the sensor electrodes are arranged in a honeycomb.

Where, the touch sensor array system comprises a plurality of electrode leads and the electrode lead connects with the sensor electrodes in the same row or column.

Where, the electrode lead bends and extends between the neighboring rows or the neighboring columns of the sensor electrodes, and the width of the electrode lead gradually changes in the row or column direction.

Where, the touch sensor unit comprises a sensor electrode and a driving electrode, and the sensor electrode surrounds the driving electrode by insulation, and the shape of the sensor electrode is hexogen, and the sensor electrodes are arranged in a honeycomb.

Where, the touch sensor array system further comprises a plurality of electrode leads, and the electrode lead connects with the driving electrodes in the same row or column, and the sensor electrodes connect with each other in a row or column.

Where, the electrode lead bends and extends between the neighboring rows or the neighboring columns of the driving electrodes and the width of the electrode lead gradually changes in the direction of the row or column.

Where, the shape of the touch sensor unit is regular hexagon.

Where, the effective touch area is circular.

The advantages of the present invention is that comparing with the prior art, the present invention installs the touch sensor units which are hexagon and arranged in a honeycomb in the effective touch area so as to cover the whole non-rectangular effective touch area by the touch sensor units. Hence, the capacitance change of the touch sensor array system of the three hexagonal touch sensor units which share the same vertex can be allocated to the three hexagonal touch sensor units, further to ensure the consistency of the touch weight.

### BRIEF DESCRIPTION OF THE DRAWINGS

FIG. 1 is the schematic diagram of arrangement of touch sensor units of the circular effective touch area of the touch panel of the prior art;

FIG. 2 is the schematic diagram of the first embodiment of the touch panel of the present invention;

FIG. 3 is the schematic diagram of the second embodiment of the touch panel of the present invention;

FIG. 4 is the schematic diagram of the preferable embodiment of the touch screen of the present invention.

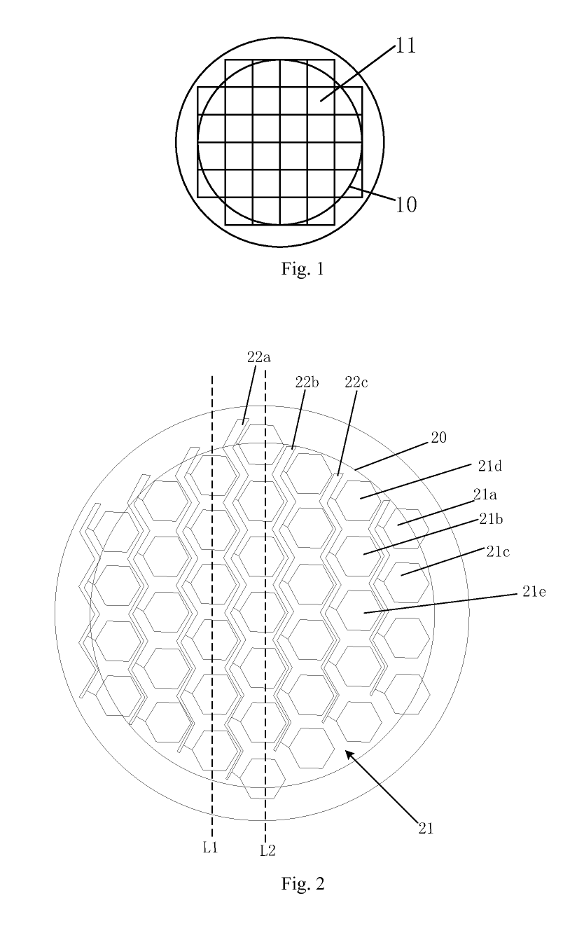

### DETAILED DESCRIPTION OF THE PREFERRED EMBODIMENTS

The detailed explanation of the present invention is the following embodiment and figures.

Please refer to FIG. 2, which is the schematic diagram of the first embodiment of the touch panel of the present invention. In the first embodiment, the effective touch area 20 of the touch panel is non-rectangular. Preferably, the effective touch area is circular. In other embodiment, the shape of the effective touch area 20 can also be ellipse or other non-rectangular shape.

The touch panel comprises a touch sensor array system 21 covering the effective touch area 20. The touch sensor array system 21 comprises a plurality of touch sensor units 21a, 21b, 21c, 21d, 21e and a plurality of electrode leads 22a, 22b, 22c. The shape of the touch sensor units 21a, 21b, 21c is hexagon and they are arranged in a honeycomb. Preferably, the shape the touch sensor units 21a, 21b, 21c, 21d, 21e is regular hexagon. It is worth noting is that only five of the touch sensor units and only three of the electrode leads are marked in FIG. 2, but they are not limited in their amount of 5 or 3. The labels of the touch sensor units and the electrode leads are selected partially for being shown schematically.

Preferably, in the first embodiment, touch sensor units 21a, 21b, 21c, 21d, 21e respectively comprises a sensor electrode 21a, 21b, 21c, 21d, 21e. The shape of the sensor electrodes 21a, 21b, 21c, 21d, 21e is hexagon and they are arranged in a honeycomb. In the first embodiment, the touch sensor units 21a, 21b, 21c, 21d, 21e are sensor electrodes 21a, 21b, 21c, 21d, 21e.

Preferably, the sensor electrodes 21d, 21b, 21e in the same row or column electrically connect with the same electrode lead 22c. More preferably, as shown in FIG. 2, according to the first embodiment, along the column direction, the sensor electrodes 21d, 21b, 21 e in the same column connects with the same electrode lead 22c.

The electrode lead bends and extends between the neighboring rows or the neighboring columns of the sensor electrodes, and the width of the electrode leads 22a, 22b, 22c gradually changes in the row direction or the column direction. Preferably, as shown in FIG. 2, according to the first embodiment, the electrode lead 22a bends and extends between the neighboring columns L1 and L2 and the width of the electrode line 22a, 22b, 22c gradually reduces from top to bottom in the column direction.

Preferably, the three neighboring sensor electrodes 21a, 21b, 21c constitute a touch triangular array which the touch triangular array is used to detect the user touch position.

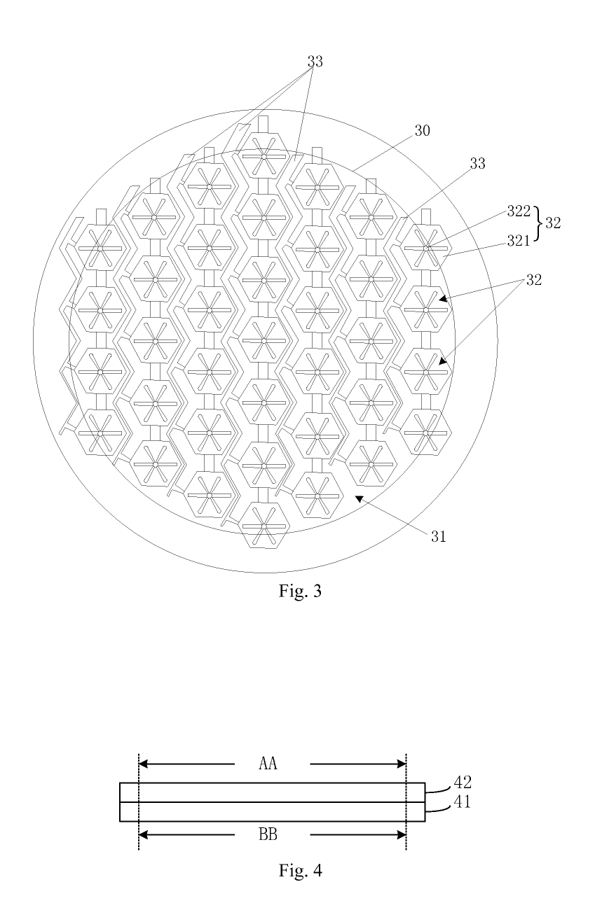

Please refer to FIG. 3, which is the schematic diagram of the second embodiment of the touch panel of the present invention. In the second embodiment, the effective touch area 20 of the touch panel is non-rectangular. Preferably, the effective touch area is circular.

The touch panel comprises a touch sensor array system 31 of the effective touch panel 30. The touch sensor array system 31 comprises a plurality of touch sensor units 32 and a plurality of electrode leads 33. The shape of the touch sensor units 32 is hexagon and they are arranged in a honeycomb. Preferably, the shape of the touch sensor units 32 is regular hexagon.

Preferably, in the second embodiment, the touch sensor unit 32 comprises a sensor electrode 321 and a driving electrode 322. The sensor electrode 321 surrounds the driving electrode 322 by insulation. The shape of sensor electrode 321 is hexagon and they are arranged in a honeycomb.

Preferably, the driving electrode 322 in the same row or column connects electrically with the electrode lead 33. The sensor electrode 322 in the same row or column connects to each other. More preferably, according to the second embodiment, as shown in FIG. 3, the driving electrodes 322 in the same column electrically connects with the same electrode lead 33, and the sensor electrodes 322 in the same column connects to each other.

Preferably, the electrode lead 33 bends and extends between the neighbor rows or columns of the driving electrodes 322, and the width of the electrode lead 33 gradually changes in the row or column direction. More preferably, as shown in FIG. 3, according to the second embodiment, the electrode lead 33 bends and extends between the neighboring columns of the driving electrodes 322, and the width of the electrode lead 33 gradually reduces from top to bottom in the column direction.

Preferably, the three neighboring touch sensor units 32 constitute a touch triangular array. The touch triangular array is used to detect the user touch position.

Please refer to FIG. 4 which is the schematic diagram of the preferable embodiment of the touch screen of the present invention. In the embodiment, touch screen comprises a display panel 41 and a touch panel 42 installed on the display panel 41. The touch panel 42 is the one described in the above mentioned embodiments. The effective display area BB of the display panel 41 is non-rectangular, and is installed correspondingly with the effective touch area AA of the touch panel 42. Preferably, the effective display area BB of the display panel 41 is circular and the effective touch area AA of the touch panel is also circular.

In comparison with the prior art, the present invention installs the touch sensor units which are hexagon and arranged in a honeycomb in the effective touch area so as to cover the non-rectangular effective touch area by the touch sensor units. Hence, the capacitance change of the touch sensor array system of the three hexagonal touch sensor units which share the same vertex can be allocated to the three hexagonal touch sensor units, further to ensure the consistency of the touch weight.

The foregoing preferred embodiments of the present invention are illustrative, rather than limiting, of the present invention. It is intended that they cover various modifications, and similar arrangements be included within the spirit and scope of the appended claims, the scope of which should be accorded the broadest interpretation so as to encompass all such modifications and similar structures.

What is claimed is:

1. A touch panel comprises an effective touch area which is non-rectangular, wherein the touch panel comprises a touch sensor array system covering the effective touch area, and the touch sensor array system comprises a plurality of touch sensor units, and the shape of the touch sensor unit is hexagon, and the touch sensor units are arranged in a honeycomb.

2. The touch panel as claimed in claim 1, wherein each of the touch sensor units comprises a sensor electrode, and the shape of the sensor electrode is hexagon, and the sensor electrodes are arranged in a honeycomb.

3. The touch panel as claimed in claim 2, wherein the touch sensor array system further comprises a plurality of electrode leads and the electrode lead connects with the sensor electrodes in a same row or column.

4. The touch panel as claimed in claim 3, wherein the electrode lead bends and extends between neighboring rows or neighboring columns of the sensor electrodes, and width of the electrode lead gradually changes in the row or column direction.

5. The touch panel as claimed in claim 1, wherein the touch sensor unit comprises a sensor electrode and a driving electrode, and the sensor electrode surrounds the driving electrode by insulation, and the shape of the sensor electrode is hexagon, and the sensor electrodes are arranged in a honeycomb.

6. The touch panel as claimed in claim 5, wherein the touch senor array system further comprises a plurality of electrode leads, and the electrode lead connects with the driving electrodes in a same row or column, and the sensor electrodes connect with each other in a same row or column.

7. The touch panel as claimed in claim 6, wherein the electrode lead bends and extends between neighboring rows or neighboring columns of the driving electrodes and width of the electrode lead gradually changes in the row or column direction.

8. The touch panel as claimed in claim 1, wherein the shape of the touch sensor is regular hexagon.

9. The touch panel as claimed in claim 1, wherein the effective touch area is circular.

10. A touch screen, wherein the touch screen comprises a display panel and a touch panel located on the display panel, and an effective touch area of the touch panel is non-rectangular, wherein the touch panel comprises a touch sensor array system covering the effective touch area, and the touch sensor array system comprises a plurality of touch sensor units, and the shape of the touch sensor unit is hexagon and the touch sensor units are arranged in a honeycomb, and an effective display area of the display panel is non-rectangular and installed correspondingly with the effective touch area of the touch panel.

11. The touch screen as claimed in claim 10, wherein the touch sensor unit comprises a sensor electrode, and the shape of the sensor electrode is hexagon, and the sensor electrodes are arranged in a honeycomb.

12. The touch screen as claimed in claim 11, wherein the touch sensor array system comprises a plurality of electrode leads and the electrode lead connects with the sensor electrodes in a same row or column.

13. The touch screen as claimed in claim 12, wherein the electrode lead bends and extends between neighboring rows or neighboring columns of the sensor electrodes, and width of the electrode lead gradually changes in the row or column direction.

14. The touch screen as claimed in claim 10, wherein the touch sensor unit comprises a sensor electrode and a driving electrode, and the sensor electrode surrounds the driving electrode by insulation, and the shape of the sensor electrode is hexogen, and the sensor electrodes are arranged in a honeycomb.

15. The touch screen as claimed in claim 14, wherein the touch sensor array system further comprises a plurality of electrode leads, and the electrode lead connects with the driving electrodes in a same row or column, and the sensor electrodes connect with each other in a same row or column.

16. The touch screen as claimed in clam 15, wherein the electrode lead bends and extends between neighboring rows or neighboring columns of the driving electrodes, and width of the electrode lead gradually changes in the row or column direction.

17. The touch screen as claimed in claim 10, wherein the shape of the touch sensor unit is regular hexagon.

18. The touch screen as claimed in claim 10, wherein the effective touch area is circular.
